(19) United States
(12) Patent Application Publication
(10) Pub. No.: US 2023/0348829 A1
(43) Pub. Date: Nov. 2, 2023

(54) Enhanced Chemical and Physical Aging of Spirits

(71) Applicant: Michael P. Ryan, Katy, TX (US)

(72) Inventor: Michael P. Ryan, Katy, TX (US)

(21) Appl. No.: 17/905,706

(22) PCT Filed: Mar. 6, 2021
(86) PCT No.: PCT/US21/21269

§ 371 Date: Sep. 6, 2022

Related U.S. Application Data
(60) Provisional application No. 62/986,036, filed on Mar. 6, 2020.

(51) Int. Cl. C12G 3/07; C12H 1/22

(52) U.S. Cl. CPC C12G 3/07; C12H 1/22

(57) ABSTRACT

The present invention is related to the accelerated aging of spirits through a centrally deposed, substantially vertically placed insert in a volume of spirits or alcohol. The insert may be a segment of charred wood, namely oak, in a specific volume and percentage of ethyl alcohol containing liquid. The present invention's novelty is a result of the vertical orientation of said insert of charred wood and the realized effects of such placement wherein a number of physical and chemical reactions occur as a result of specific interactions between alcohol and air trapped within the wood. The resulting comingling of wood and alcohol containing liquid facilitates release of certain coloring and flavor components, leaching from the wood and into the surrounding liquid, which leads to a hastening of the aging process.

### FIELD OF INVENTION

The present invention relates to the accelerated aging of spirits through a centrally deposed, substantially vertical placement of a discretely sized linear, solid segment of charred wood, namely oak, in a specific volume and percentage of ethyl alcohol containing liquid, generally. More specifically, the present invention's novelty is a result of the vertical orientation of said linear, solid segment of charred wood and the realized effects of such placement wherein a number of physical and chemical reactions occur as a result of specific interactions between alcohol and air trapped within the wood. The resulting comingling of wood and alcohol containing liquid facilitates release of certain coloring and flavor components, leaching from the wood and into the surrounding liquid, which leads to a hastening of the aging process,

### DESCRIPTION OF THE RELATED ARTS

Spirits have been distilled (from the latin dēstillāre' meaning “dripping”) from grains for many centuries and there exists innumerable recipes and methods for spirit distillations and aging processes that have been utilized by various cultures globally to enhance the texture, smell and taste of alcoholic liquids. In fact, fermented grains, fruits and honey can be traced back to 7000 BC in China in the Henan province, 5400-5000 BC in Hajji Firuz Tepe, Iran and roughly 3000 BC in ancient Egypt and Babylon. And while wine can ferment largely autonomously and beer may be brewed with slightly more effort, the distillation of alcohol is much more involved requiring a discrete sagacity and skill.

Requiring a developed knowledge of the chemical arts, it is believed that the distillation process can be traced back to China, Italy or even Arabia. And, while it is commonly accepted distillation was developed by in the far east and middle east, the first actual description of modern distillation (i.e. heating, vaporizing/evaporation and subsequent condensation) occurs in the middle ages and is ascribed to Albertus Magnus aka Albert le Grand or Albert the Great (living from 1193-1280) in the treatise De Secretis Mulierum or ‘Of the Secrets of Women’ which may well have been used initially in perfumery or medicinal waters more so than alcoholic beverages.

Moving up through the middle ages, with the transition from alchemy to chemistry, into the more modern era, it can be observed that distillation can be bifurcated generally into either differential (‘batch’) distillation or continuous distillation where, as the name would suggest, in the former, ‘batch’ distillation, separation occurs as the result a single process and, in the later, the process in ongoing with continuous fractionating running at a steady state wherein ‘set’ concentrations do not change over time. Although, each method differs on process, the end product is crudely similar. And wherein distillation was originally involved with alcohol concentration in perfumes, essential oils and imbibed spirits, the goal of concentrating alcohol into a condensed distillate has undergone numerous efficiencies of process thereby resulting in effectiveness in the methods of procurement with varying degrees of percentage content (‘proof’) and enhanced purity.

Pointedly, the emergence of petrochemical engineering and ocean water desalination, as well as advanced computer capabilities and analytics, evidence the greatest advancements of production but all terminate in commensurate end points—a higher desired species content and concentration with fewer to no impurities.

Historically, newly distilled alcohol containing spirits, including primarily whiskeys, scotches, tequilas and rums, are first produced by germinating grains (e.g. wheat, barley, rye or corn) in water, thus releasing enzymes that break down starches into sugars. The grains are then dried to halt the germination process and yeast and water are added to convert the sugar to alcohol and carbon dioxide. The alcohol produced is a blend of various alcohols (methanol and fusel alcohols) and other congeners (e,g. acetone, acetaldehyde, esters, tannins and aldehydes) wherefrom ethanol is preferably separated out and concentrated in the next phase, distilling. But the yeast can only operate to a certain point (approximately 14 to 18 ABV) wherein higher concentrations of ABV proves toxic to the yeast and hampers the yeast's ability to process sugars which decreases precipitously. At that point, no higher alcohol content can be achieved due to the yeasts inability to operate efficiently. To produce a higher alcohol content, the alcohol must be physically separated from water and concentrated, through evaporation and condensation (i.e. distilling), to a higher ABV.

The distilled ethanol spirit is then placed into a charred barrel, typically oak in the case of bourbons and scotches, admixed with water and the mixture is then made reliant upon a wooden barrel to filter out impurities with increased pressure and temperature, due to warmer weather, and the pores releasing the mixture into the barrel, with various molecules in tow. Cooler temperatures act in just the opposite manner, creating the reverse gradient, sending the spirits back into the wood. The back-and-forth movement of the spirits over time is ultimately responsible for the overall complex color and flavor profile the spirits gain over the seasons (typically measured in years of aging).

Whiskeys, bourbons in particular, are a traditional American spirit distilled from a minimum of 51% corn as well as other grains. The spirit is then aged in charred American white oak barrels over various lengths of times (e.g., years) to achieve the aged color and flavors most associated with a “mature” spirit. Greater time lengths and temperature and pressure induced “agitations”, increase movement into and out of the wood in the barrelnd facilitate the characteristics that the spirits will come to exhibit. As well, other additives and excipients may be introduced into the barrel to achieve desired colors and flavor profiles.

Prior art includes a multitude of physical, chemical, heat-induced and pressure-induced accelerators. Most of these accelerators incorporate the addition of charred wood chips, blocks and boards introduced into oak barrels for accelerated aging processes. Moreover, some inventions have moved the various wood forms directly into the bottle with a mix of various levels of success. In fact, patents dating back to the early 1900's discuss various methods of aging and flavoring spirits through a multitude of both physical and chemical processes.

Prior inventions consider placing various types of sticks or pellets/chips into wooden barrels to enhance aging and flavoring process efficiencies. In addition, recent patent applications involve placing wood chips/fragments in various pressure vessels and passing liquor distillates through or over the chips at increased pressures and temperatures, possibly even using flow-inducing vacuums, to accelerate the aging and flavoring process. Still other methods include simply placing some form of a wood chip/fragment/piece into a bottle or container that either settles in the bottom, floats atop the liquid or a combination thereof.

Recent innovations include various additives, pressure, light, temperature, ventilation, vibration (e.g. ultrasound) and membrane filter process applications and technologies designed to artificially age, or accelerate the aging of, new (white) whiskeys and bourbons. Wood lined containers, wood chips, wood shavings, wood extracts, spiral cut sticks, sugar-rich syrups, and ethyl acetate have also been common market offerings and have been placed in the barrels, casks or individual bottles in order to expedite the aging process.

Many such patents exist which discuss the use of increasing the surface area of the wood in contact with the spirits in order to provide the maximum contact of alcohol with the wood, but no attention has been paid to the virtues of the (1) the central placement and (2) vertical orientation of the wood and its effects on accelerated aging. In fact, it is this centrally deposed, upright (vertical) orientation that goes to the heart of the present invention in that the centralized and perpendicular positioning establishes a system wherein all exterior sides of the wooden “stick” are exposed to the alcohol of the spirit—giving the alcohol unfettered access to the wood and contact to the oxygen contained within. And, while naturally occurring convective forces, created by temperature differences throughout the bottle, interplay with natural air bubbles residing within and exiting the wood to create an autonomous flow, the exodus of said bubbles additionally generates further augmented liquid flow. Further, the reverse buoyancy of the wood, due to the loss of trapped oxygen, causes the wood “stick” to slowly sink and thereby creating additional movement in the bottle. Agitation itself can be influenced exteriorly through exogenous physical movement as well through transport of the bottles themselves.

It can be observed that the present invention may exhibit (1) a smaller liquid to wood surface area ratio or (2) a larger liquid to wood surface area ratio (each dependent on the volume of liquid and size and dimensions of the inserted wood), in order to regulate the speed in which the aging process may occur within a container—which is a vastly superior form of exposing alcohol and water to charred wood in a dynamic as opposed to static, set ratio. Manifestly historically large and cumbersome barrels provide a largely immutable system reliant upon vast amounts of liquid and relatively small ‘exposed’ and available areas of wood where agitation and exposure are reliant primarily upon changes in temperature and resultant pressure changes to induce flow and subsequent aging. In opposite, the volume of alcohol and parameters (i.e. length, width and thickness as well as degree of charring) of the inserted wood of the present invention can lead to internal alcohol aging that is variable (i.e. mutable based on adjustments to the various parameters) and equally capable of externally derived manipulation through temperature and vibration.

Explicitly, whiskey barrels store 53 gallons or 200 liters of liquor. Whiskey barrel dimensions are 22 inches in diameter for the heads top and bottom by 36 inches in height, the circumference of the bilge will be around 26 to 28 inches. An empty barrel weighs approximately 110 lbs. and a full barrel weights approximately 520 lbs. And, although the large barrel size exhibits an equally large internal surface area, the large barrel capacity yields a correspondingly low surface to volume ratio (especially in relation to smaller capacity vessels) where said ratio is inversely proportionate to liquid volume where lower volumes result in higher ratios and therefore higher rates of contact.

As opposed to large barrels, glass or plastic whiskey bottles, on the other hand, enclose typically 750 ml to 1.5 L of liquid and weigh 1.5 to approximately 3 pounds. Consequently, a properly-dimensioned, inserted perpendicular “stick” of wood can far exceed the surface area exposable to the encapsulated liquid. As well, the bottle is much more amendable to individualized heating and agitation as compared to the barrel. Moreover, rapidity or retardation of aging may be individualized, on a bottle per bottle basis, with the present invention and method of use.

While strides have been made to overcome the inadequacies of aging spirits, it remains evident that considerable failings remain in the field. It is the goal of the present invention to remedy these shortcomings as to allow better inducement of spirit aging and to potentiate a system of improved accomplishment of the delicate operations and functions involved in accelerating the aging process.

While inventor s set forth the best mode or modes below contemplated of carrying out the invention known to inventor such to enable a person skilled in the art to practice the present invention, the preferred embodiments are, however, not intended to be limiting, but, on the contrary, are included in a non-limiting sense apt to alterations and modifications within the scope and spirit of the disclosure and appended claims.

### SUMMARY OF REPRESENTATIVE EMBODIMENTS OF THE INVENTION

New vs. Old. Barrels

Expressly, new wood (i.e., wood used to produce a straight bourbon) holds a great deal of tannin, which can sometimes come across as a “hot” or sour flavor. Alternatively, previously used wood will yield more subtle consequences in terms of ester and phenol development—when Eugenol and other esters do not compete with wood tannins and Guaiacol for expression and “attention”. These ingredients can thus be more delicately expressed. Often vintage (i.e. previously used) American oak barrels are utilized to develop delicate profiles for their final blend in products ranging from wines to liquors to beer. As aging is a natural process, and all barrels age at their own pace and impart their own flavor profile to the whiskey, a specific barrel may trigger one or more of a desired profiles, including Clove (spice) Orange (fruity) or Vanilla (vanillin) recognized as ‘COV’. The result is the higher vanillin from this ‘used’ oak will help to make subsequently treated batches more flavorful and complex. With less spice flavor present, more subtle and smooth flavors can be unmasked and expressed. The consequences of the use of “new” as opposed to “old” barrels can be evidenced where “new” barrels impart a flavor that is stronger and bolder whereas a “used” barrel conveys flavors that are more mellow and gentler on the palate.

### Proof

The proof specification that goes into a barrel for aging also has a distinctive effect. It impacts solubility wherein spirits will dissolve more water-soluble flavors at lower proof levels and strictly high tannin extraction at higher proof levels. At 120 proof, which is the traditional proof level for introducing spirits into a barrel, there will be a great deal of alcohol soluble tannins pulled out of the wood. If it goes in at a lower proof, typically under 100, it will extract more delicate and nuanced water-soluble compounds.

### Double-Oaked Spirits

Traditionally, a “double oaked” spirit is first aged in a new charred oak barrel at 120 proof. Then it is transferred to a second used barrel at the same proof level. It is the object of the present invention to achieve both outcomes by a new and novel advanced aging approach. First the spirits are aged normally in charred oak barrels as would be evidenced in a traditional method. The next step in the process is dilution to a proof level of under 100, specifically in the 95-proof range. Finally, the spirit is transferred to the desired container and thus ‘bottled’. It is in this final stage that the present invention is utilized, and an unused charred oak stick is introduced to the spirits bottle for continued aging. This introduces a higher percentage of wood tannins, esters, sugars and phenols per surface contact area than would be if a used wood surface from a prior barrel was introduced into the spirit. At the lower proof level, the softer, smoother flavor compounds are extracted from the charred wooden insert to achieve a unique product that is continually aged after bottling.

In a preferred embodiment, the present invention is directed to an aging process that occurs when a “fire” or “flame” charred wooden stick is placed vertically in a container, wherein the container dimensions are vertical in nature as opposed to the traditional oak barrel—which is stored horizontally.

In another related embodiment, the container may be comprised of various materials sufficient to hold distilled spirits so long as the bottle's height is substantially larger than its width.

In another related embodiment, one or more wooden sticks, planks, dowels or inserts are placed inside a container in a vertical fashion-defined as within 45 degrees of a vertical orientation whereby the wooden sticks, planks, dowels or inserts are deposed in the center of the bottle, allowing for the liquid to contact all sides of the wood.

In another related embodiment, the sticks planks, dowels or inserts may be comprised of various species of wood and may be fresh, charred or recycled used from prior applications such as old bourbon or wine barrels).

In another related embodiment, the wooden sticks planks, dowels or inserts may be composed of various dimensions such as round, square, rectangular or spiral cut as to facilitate lesser or greater exposed surface area of wood to alcohol ratios.

In another related embodiment, one to multiple sticks planks, dowels or inserts may be “hung” (suspended from the bottle's top) internally on hangers designed to space the multiple “sticks” apart inside a container sufficient to achieve proper exposed area of wood.

In another related embodiment, the surface area of the sticks, planks, dowels or inserts may be constructed to be less than, equal to, or greater than the ratio of spirits to wood surface area in a traditional spirits barrel of approximately 53 gallons, as outlined below:

The ratios are detailed in the table below:

| | | | Ratio to | | | |
|---|---|---|---|---|---|---|
| Volume | Surface Area | Surface to | 53 Gallon | Days = | Weeks = | Months = |
| (Liters) | (Sq. Inches) | Volume Ratio | Barrel | 1 yr | 1 yr | 1 yr |
| 1 | 206 | 206 | 6.31 | 58 | 8.24 | 1.9 |
| 2 | 297 | 148 | 4.54 | 80 | 11.45 | 2.64 |
| 3 | 398 | 133 | 4.07 | 90 | 12.79 | 2.95 |
| 5 | 569 | 114 | 3.49 | 105 | 14.92 | 3.44 |
| 10 | 892 | 89 | 2.73 | 134 | 19.04 | 4.39 |
| 20 | 1382 | 69 | 2.12 | 173 | 24.58 | 5.67 |
| 200 or | 6535 | 33 | 1 | 365 | 52 | 12 |
| 53 gal. | | | | | | |

Ref: https://www.homebrewing.org/assets/images/PDF/Barrel%20FAQs.pdf

Note: a standard 53 gallon/200 L barrel has an interior surface area of 6535 sq. in. with a surface to volume ratio of 32.675 sq. in./liter or 6535 sq. in/7061 oz.=0.9255sq. in./oz.

In other embodiment, new (white) or aged spirits may be placed in a vertical container with the wooden (charred) sticks whereby the bottle is then capped or closed and sealed.

In another embodiment, temperature changes, in the form of increases and/or decreases, may be applied to the vertical container to create increases and/or decreases in convection currents and an increase or decrease in the efficiency of the vertical aging process. In the example provided above, temperature increases would be applied to a bottle in order to accelerate aging.

In another embodiment, pressure changes, increases and/or decreases of which, may be applied to the vertical container to create an increase in the efficiency (or slowing) of the vertical aging process.

In another embodiment, both pressure and temperature changes, and any combination of increases and/or decreases, may be applied to the vertical container to create an increase or decrease in the time and efficiency of the vertical aging process.

In certain other embodiments, vibration may be applied, in increasing and decreasing rates, to said vertical container to induce accelerated aging or slow aging through agitation and/or alternating the two temporally.

In yet another embodiment, a combination of temperature, pressure and vibration changes may be applied to an alcohol and wooden stick combination, in various sequences and arrangements whereby aging is accelerated.

### Mechanism of Action

There are multiple processes which occur when placing a centrally disposed, vertically oriented insert (preferably a wooden stick, block, plank or dowel, which may equally be a metal, glass or plastic insert, in some instances) in a specific volume container of liquid of any size and shape, defined as a container that is rectangular (i.e. taller than it is wide).

As described above in the preferred embodiment, wood is naturally comprised of air pockets which give the inserted stick, block, plank or dowel a buoyant characteristic. Due to the vertical orientation of the stick, its weight is concentrated across a very small surface area which will cause the stick to sink over time as trapped air evacuates and leaches out into the surrounding liquid. As the stick trades air for liquid, the stick will also exude various resin compounds within the spirits wherein air displacement will allow the spirits to permeate the wooden stick's abandoned chambers and to absorb various resins giving the spirits a characteristic color and flavor profile, upon ultimate exodus, as determined by the makeup and charring of the wood. Movement of air out of the wood induces further flow within the liquid and allows for fluid movement within the space.

In an additive mechanism, changes in temperature between the stick and its surroundings will cause natural convection to occur thereby creating a circulatory action which enhances fluid flow and the subsequent aging and flavoring process.

In another mechanism, the changes in pressure within the spirit containing chamber may induce the aforementioned fluid flow, exchange and thus the aging process. Manifestly, it is observed that barrels stored at a higher altitude location vary in flavor from those stored at lower altitudes due to changes in ambient pressure.

In yet another mechanism, vibration may increase agitation which further augments the natural convective forces induced by pressure and temperature.

In yet another mechanism, temperature, pressure and agitation may be used sequentially, simultaneously, or a combination thereof, to induce, reduce, modify or augment liquid and gas flow to hasten the aging process.

### DETAILED DESCRIPTION

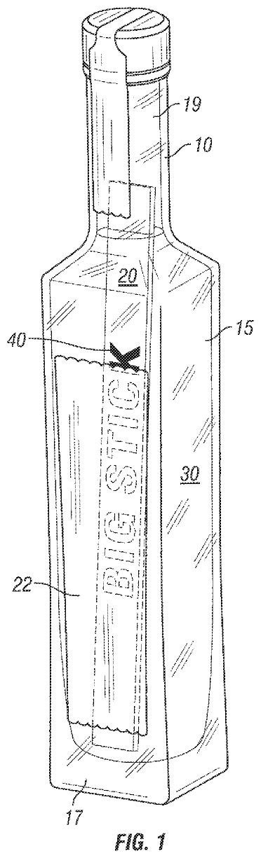

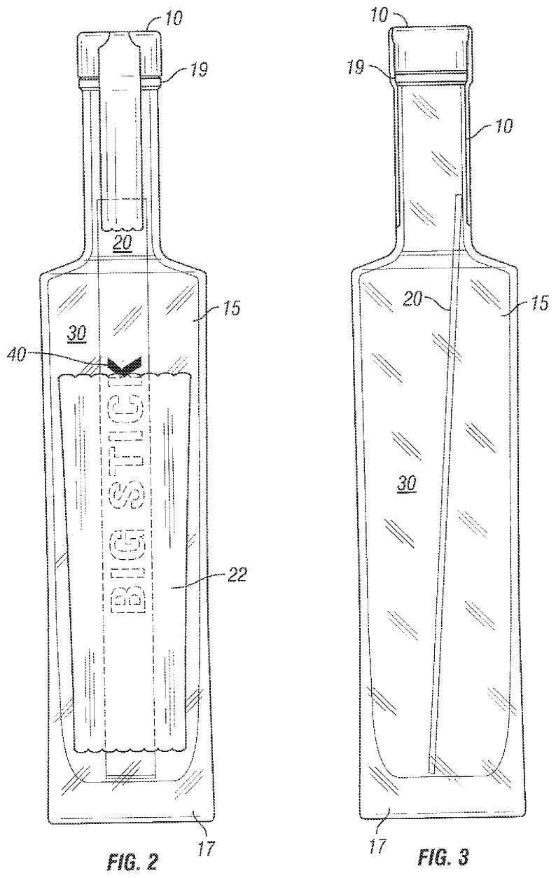

As depicted in FIGS. 1-6, the present invention 10 is unique in that it takes advantage of (1) the natural interactions of air and liquid in a submersed wood, (2) convection and (3) gravity to promote aging and flavor enhancement inside a bottle 15 or container. This interchange is effective because the insert element 20 (which may be a wooden stick, block, plank or dowel) is placed in a largely central and vertical position in the liquid 30 within the bottle 15 thereby using the weight of the wooden insert 20, eventual loss of buoyancy and gravity to force the wooden insert 20 element to move down through the column of distillate/liquor liquid 30. As shown, in FIGS. 1 and 2, the insert 20 is only partially obscured by a bottle label 22, but remains visible to the observer (not shown).

Whereas, naturally occurring air pockets inside the wood itself resist the sinking of the insert 20 in the liquid 30 for a period of time, eventually the weight of the wooden insert 20 increases, as the air within its fibers is displaced by liquid 30, and the eventual loss of gas elements ultimately allows the absorption of the liquid into the vacated wood insert 20 pockets. This exchange allows the movement of liquid 30 into the wooden insert 20, wood weight increase and sinking of the wood to the container's bottom 17. Because oflocal temperature gradients at several points within the bottle/container 15, even slight variations in temperature and the temperature differences created between the bottle bottom 17 and top 19 of the bottle produce convection currents which facilitate, accelerate and improve the efficiency of the aging/flavoring process.

### Etching and Surface Area

Also, the present invention contemplates the use of laser devices to heat the surface of the wooden insert 20 thereby charring the surface as opposed to using open flames from various sources (such as gas fired torches, fossil fuels or natural products such as wood or charcoal fires) to char. A normal charring process using open flames has great variances in quality of charring because all wood dimensions are by definition organic, varied and inexact. The use of laser etching provides uniformity (accuracy and repeatability) of charring and char patterns, and a safe alternative to open flame, without any residual flavors imparted by either natural wood burning or fossil fuel fire byproducts of combustion.

Precisely, the advantages of using lasers to heat and char the surface of the wood insert 20 is that the surface char depth (i.e. amount of actual charring) can be more precisely controlled throughout the charring process. Too, in addition to a more precise depth of charring, the charring itself, through the use of laser etching, can now be repeated with a regularity that engenders into the process a uniformity and consistency that was before unattainable. With the use of laser etching, the char quality may be variably adjusted to produce any combination or preference with regards to a light, medium, or heavy char in addition to creating variable patterns on the insert 20. Further, lasers may be used to slow heat or pre-heat wood surfaces to achieve a greater depth of toast and/or char prior to engaging a higher energy process in the actual charring of the wood surface, Any combination of multiple energy levels or length of time may be used to achieve a specific char etching design (see specifically FIGS. 1, 2, 4 and 5) for exemplary text laser etching) or multiple layers of varying toast or char within the thickness of the medium is achievable.

Specifically, the laser power level may be variable to include: beam(s) which may be pulsed or continuous beam or multi-beam; variable spot sizes; and variable duration and/or width of the pulses; variable ble distances between laser and wood. In addition, the laser may be part of a device that: has the ability to follow/rotate along curved surfaces; the ability to remain stationary and rotate the wooden surface; the ability to visually inspect the char level (color) of a surface; the ability to adjust based on visual monitoring; the ability to vacuum or clear away smoke and particles given off in the process; encompasses sensors to determine distance from work surface, energy levels and speed and acceleration of laser device or work piece; and/or may have the ability to be programmed with custom designs, trademarks, logos, symbols and the like.

The wooden (piece) insert 20 itself may be of any dimension allowing for insertion and acceptance into a reservoir, but as one example, the insert 20 is a wooden oak insert which is approximately 10 inches long, ¾ in wide and ⅛ in thick. Modification may be made, though, to (a) hasten or slow the aging process through increases or decreases in liquid to wooden surface area ratios, (b) adjust the inserts parameters to accommodate differing sizes of receptacles or (c) to allow for the necessary surface area to accept branding, custom design, trademarks, wording (text) (see specifically FIGS. 1, 2, 4 and 5), symbols, logos or artwork.

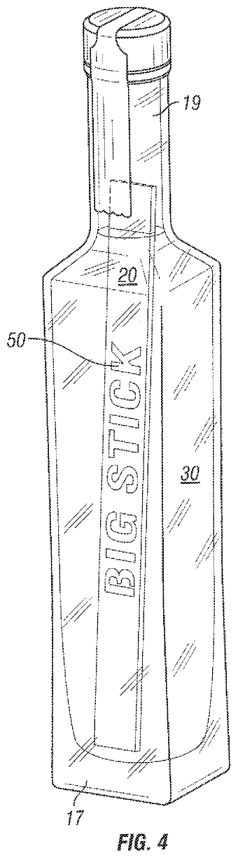

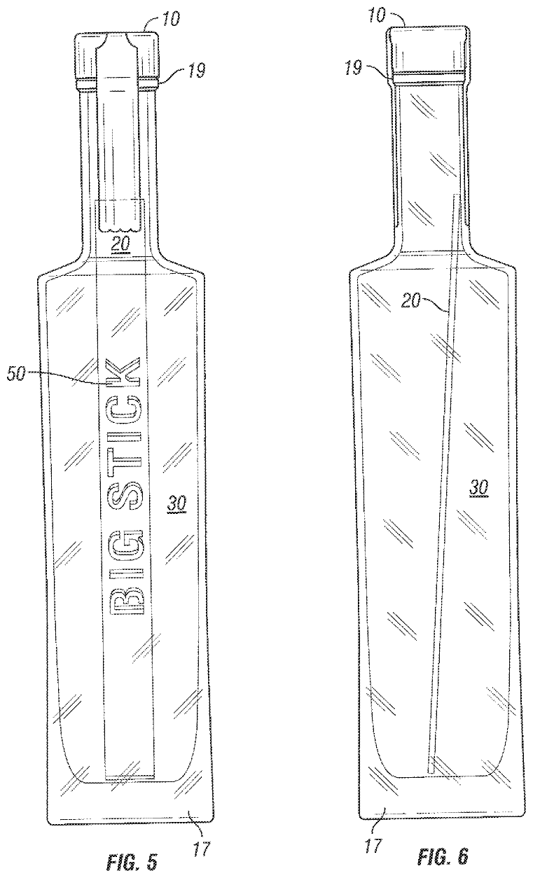

Tn terms of process, a wooden (oak) plank (i.e. insert 20) is charred to a specific degree and placed in a fluid reservoir generally taller than it is wide. The insert 20 itself may be allowed to float freely or placed into one of various hanger arrangements (amendable to attachment to a closure or cap for insertion and removal), vertically, and/or in an orderly or random configuration that is centrally disposed or closer to the interior periphery. The insert 20 itself may be of various dimensions (size, mass, composition, number, char and/or type) as to accommodate an array of liquid 30 to surface area ratio capable of adding color and flavor at a reduced or accelerated rate to spirits and equally capable of harboring exterior text, symbols, diagrams, logos, artwork and the like (see text specifically illustrated in FIGS. 1, 2, 4 and 5). As depicted in FIGS. 1 and 2, insert. 20 evidence a laser etched ‘BIG STICK’ 40 which may be a result of directed charring or in addition to the charring. FIGS. 4 and 5 display a ‘BIG STICK’ laser etching that exhibits a depth running the entirety of the insert whereby the laser etching creates a through etching of the text.

Moreover, the insert 20 may be new, recycled or repurposed (some may be new oak char, others may be from a previously used charred wood and still others may originate from used cabernet barrels, etc.). Too the density of wood sticks calculated surface ratio may be lower, equal to, or greater than the traditional surface ratio of a 53 gallon spirits barrel. The column of liquid too is variable and may be adjusted as to fix and calibrate the wood surface to liquid ratio.

Furthermore, exogenous factors may be adjusted in order to manipulate the convection action within the column of liquid. Adding a heating element at the base of the column will increase convection flow within the column thereby increasing the flavor and color modification process and decreasing the time to achieve the desired flavor and appearance. Conversely, adding a cooling element to the top of the column increases convection flow within the column thereby increasing the flavor and color modification process and decreasing the time to achieve the desired flavor and appearance. What's more, Heating and cooling elements may be used in combination at various points about a container. Too, an external vibratory force may be applied to a container or vessel harboring both a charred stick and an alcoholic mixture in order to agitate the container and contents in order to induce and facilitate accelerated aging.

On a larger scale, an internal nixing motor/blade combination may be used to create vertical circulation to increase the efficiency of the process whereby the column of a container may be open or sealed at the top to prevent evaporation.

To the point of larger scale, traditional methods of aging use 53 gal barrels stored for many, years whereby a finishing process involves emptying one barrel of spirits into another barrel, usually a previously used barrel from a wine or other type of spirit. Some distilleries add charred sticks to existing barrels in order to accomplish an augmented flavoring process, but, as opposed to the current invention, those barrels are horizontal barrels with a fixed capacity that are not easily manipulated or maneuvered.

In opposite, the current process creates a high efficiency, variable and unlimited volume capacity system with any combination of wood, or other flavoring agents. In addition, the current invention incorporates an added dimension of color augmentation. Too, the primary conduit utilized to augment the color, flavor and time of aging itself can be used for other manufacturer, consumer and distributor functions (monitoring, tracking and authenticity verification) in products ranging from perfumes to non-alcoholic consumables, cleaning agents and other like container and liquid arrangements—each benefiting from the present invention and related permutations.

### Advantages

Although advantages will be readily evident to those having requisite skill in the art, inventor notes several instances where ‘laser char’ is advantageous over open flame charring which are are described, but not limited to, the following: higher consistency between and among char depths; variable char darkness (extent), as well as depth, due to controllable heat settings; the ability to add or mix multi-dimensional words, symbols, designs and patterns of any description, while also preserving char uniformity, if desired; adding branding, anti-counterfeiting and\or marketing properties by marking sticks with manufacturer information, up to and including trademarks; and the ability to add manufacturer RFID (Radio Frequency Identification) or other anti-counterfeiting devices or ags inside the bottle attached to (or within) the insert, either visible or invisible, internally within or externally adhered to the insert;

In one depiction of advantage, the insert may be of any material, soluble or insoluble in the liquid filled container. The insert may be made of any combination of solid or porous, rigid or flexible, absorbent or non-absorbent material. It may be inscribed with any multi-dimensional writing, texts, symbols, logos, trademarks, designs, artwork or patterns that may be of any size, shape or form in relation to the insert, size. Said writing, texts, symbols, logos, trademarks, designs, artwork or patterns may be used to convey branding, ingredients information or any form of marketing; promotional, advertising, legal, sweepstakes, or contest information and the like.

In yet another depiction, the insert may be an expandable insert whereby said expandable materials may exhibit an interiorly deposed branding label, interiorly maintained text (see specifically FIGS, 1, 4 and 5), a design, logo or a specific piece of artwork specific to the brand. of contents allowing consumers to both identify and distinguish between and among products.

In another illustration, an insert (wooden stick) may be impregnated with certain colors and/or flavoring or scent agents or chemicals as to alter or enhance the liquid properties of the fluid inside the container. For an example, a plastic stick may be colored yellow and have the markings of a certain brand of whiskey or vodka, either information and/or logos, as well as contain flavoring chemicals such that they impart a lemon flavoring to the liquids. It may also contain coloring chemicals that impart a slight yellow color to the liquid, for example.

Similarly, in another permutation, a stick or rod may be added to a non-potable liquid (e.g. a cleaning solution, a solvent or a bleaching agent) wherein said stick may contain a blue coloring that also imparts a blue color to said liquid inside a container with a non-palatable, non-potable chemical smell or taste designed to prevent accidental ingestion.

In another example the stick or additive element medium may contain agents which change the viscosity of the liquids inside the container.

In another embodiment, the labelling requirements information may be placed on an inert medium inside the bottle or container to prevent any information (up to and including a visually recognizable text and/or QR code, exteriorly, or a radiofrequency identifier, externally or internally, from rubbing off during shipping and handling. This label can be of any shape or size as to satisfy labelling regulations.

In another example, these label-in-bottle parts may contain either barcodes or RFID tags or other forms which may be used as a tracking aid, a monitoring device or an anti-counterfeiting devices, or a combination thereof, among other practical functionalities.

The current invention may be called a label-in-bottle (‘LIB’) design thus differentiating it from the customary and traditional label-on-bottle (LOB’) design.

Advantages, which are discoverable by a person having reasonable skill in the art, are as follows: the prevention of any label information from being damaged or removed during shipping and handling; the allowance for anti-counterfeiting devices to be added to the product internally, which improves survivability of the anti-counterfeiting device while avoiding tampering and/or adulteration; ability to track and monitor product movements at all points in manufacturing, distribution and sale; Allowance for coloring and flavoring agents to be added at the end of the production process; allowance for coloring agents to be added at the d of the production process; allowance for olfactory agents to be added at the end of the production process; allowance for viscosity agents to be added at the end of the production process; allowance for magnetic devices to the inserted within a container at the end of production; allowance for illumination devices to be inserted into a container post processing; allowance for marketing information to be added at the end of the production process relating to batch; and allowance for legal/regulatory information to be added at the end of the production process.

The present design is unique in that it allows for simplification in the bottling and production of various liquids by starting with a common base element and adding the customization aspects of label information, flavor, color, smell, taste, illumination, iridescence, viscosity, tracking or other additions immediately before bottling closure.

1. An apparatus for the accelerated aging of an alcohol containing liquid, comprising:
a vertical container with a closed bottom end and an open top end:
said vertical container exhibiting a narrow neck opening into a wide container body;
said vertical container which is configured to encapsulate both a centrally disposed, vertically oriented wooden insert and an a volume of distilled alcoholic liquid;
said wooden insert placed largely vertically within the centermost area of said container whereby said wooden insert rests partially within said narrow container neck and partially within said wide container body;
said wooden insert is charred via exposure to a heat source;
said wooden insert placed in said container as to allow for exposure of exterior surface areas to alcoholic liquid; and
said open top having at least one opening that may be sealed.

2. The apparatus of claim 1, wherein said centrally disposed, vertically oriented wooden insert is oak.

3. The apparatus of claim 2, wherein said centrally disposed, vertically oriented wooden insert may be charred by an open flame or a laser to varying degrees of charring for accelerated distilled alcoholic liquid aging.

4. The apparatus of claim 3, wherein the char may be variably adjusted to produce any combination or preference with regards to a light, medium, or heavy char in addition to creating variable patterns on the insert

5. The apparatus of claim 1, wherein said centrally disposed, vertically oriented insert may be an organic or non-organic, solid or porous, rigid. or flexible, absorbent or on-absorbent, inert or non-inert, expandable and/or magnetic material which may be of various shapes and colors, illuminable or iridescent.

6. The apparatus of claim 5, wherein said centrally disposed, vertically oriented insert may exhibit any multi-dimensional writing, texts, instructions, branding, symbols, logos, trademarks, designs, trademarks, artwork or patterns that may be of any size, shape or form accommodated or accepted on said insert in relation to the insert size.

7. The apparatus of claim 6, wherein said insert may include visual, scannable QR codes, externally displayed or radiofrequency devices, internally or externally displayed for information, monitoring, tracking, shipping, analysis, authenticity and anti-counterfeiting functions.

8. The apparatus of claim 1, whereby said centrally disposed, vertically oriented charred wooden insert (1) is porous and (2) has all exterior areas exposed to said alcoholic liquid as to allow the exodus of air from all said exteriorly exhibited pores on said insert and entry of distilled alcoholic liquid into said pores thereby causing convective currents and exchange of natural wood elements into said alcoholic liquid.

9. The apparatus of claim 8, whereby said air exodus from said pores of said centrally, disposed, vertically oriented charred wooden insert and entry of distilled alcoholic liquid into said wooden insert's pores decreases said insert's buoyancy and increases said insert's weight causing said insert to move, via gravity, to the bottom of said container further inducing convective currents.

10. The apparatus of claim 9, wherein increasing temperature, pressure or vibration to said container may induce additional convective currents further accelerating the aging process.

11. The apparatus of claim 9, wherein increasing temperature, pressure or vibration to said container may induce additional convective currents further decelerating the aging process.

12. The apparatus of claim 9, wherein increasing and decreasing of temperature, pressure or vibration to said container may induce and/or reduce additional convective currents, alternating said temperature, pressure and/or vibration, sequentially, simultaneously or randomly, to further accelerate, decelerate, modify or augment, or a combination thereof, the aging process.

13. The apparatus of claim 1, wherein said liquid may be a non-potable liquid.

14. The apparatus of claim 5, wherein said insert may be impregnated with certain colors and/or flavoring or scent agents or chemicals as to alter or enhance the liquid properties of the fluid inside the container and/or change the viscosity of said liquid.

15. The apparatus of claim 6, wherein said wooden insert may be impregnated with certain colors and/or flavoring or scent agents or chemicals as to alter or enhance the liquid properties of the fluid inside the container.

16. The apparatus of claim 7, wherein said liquid may be a non-potable liquid.

17. The apparatus of claim 16, wherein the non-potable liquid is a perfume.

18. A method of accelerating the aging of an alcoholic liquid comprising:
aging an alcoholic spirit in a charred oak barrel;
diluting said spirit to a proof under 100;
transferring the spirit into a vertically oriented container;
placing a charred oak wooden insert, centrally and vertically, into said vertically oriented container;
sealing said container;
allowing said alcoholic liquid to enter the pores of said wooden insert as air is released from said pores, thus creating convection;
allowing said insert lose buoyancy and gravitate to the bottom of said container, enhancing convective flow; and
allowing wood constituents (e.g. wood tannins, esters, sugars and phenols) to move from said wood to said alcoholic liquid.

19. The method of claim 17, wherein temperature, pressure or vibration is added sequentially, simultaneously or randomly, to further accelerate, decelerate, modify or augment, or a combination thereof, the aging process.

20. A method of providing identifying, monitoring, analytical and informational data internally within a container comprising:
adding identifying, monitoring, analytical and informational data to an insert, internally within said insert, externally on said insert, or a combination thereof; and
placing said insert within a container whereby data can be retrieved visually or through a reading device.
